(19) United States
(12) Patent Application Publication
(10) Pub. No.: US 2006/0209838 A1
(43) Pub. Date: Sep. 21, 2006

(54) Method and system for estimating average bandwidth in a communication network based on transmission control protocol

(75) Inventors: Young-Ha Jung, Yongin-si (KR); Se-Hun Hwang, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/377,719

(22) Filed: Mar. 17, 2006

(30) Foreign Application Priority Data
Mar. 17, 2005 (KR) 10-2005-0022064

(51) Int. Cl. H04L 12/56

(52) U.S. Cl. 370/394; 370/468

(57) ABSTRACT

A method and system for estimating an average bandwidth in a wired/wireless communication network with a time-varying rate are provided. In a TCP network, differences between inter-arrival times and sequence numbers of current and previous Acks are calculated. The estimated bandwidth of the previous Ack and a sample bandwidth of the current Ack are calculated. The inter-arrival time of the current Ack is compared with the inter-arrival time of the previous Ack. A first weight to be multiplied by the estimated bandwidth of the previous Ack and a second weight to be multiplied by the sample bandwidth of the current Ack, according to the comparison, are determined. The bandwidth of the current Ack is estimated by weighting the estimated bandwidth of the previous Ack with the first weight, and weighting the sample bandwidth of the current Ack with the second weight.

### PRIORITY

This application claims the benefit under 35 U.S.C. § 119(a) of a Korean Patent Application filed in the Korean Intellectual Property Office on Mar. 17, 2005 and assigned Serial No. 2005-22064, the entire disclosure of which is hereby incorporated by reference.

### BACKGROUND OF THE INVENTION

1. Field of the Invention

The present invention relates generally to a method and system for estimating the bandwidth of a wired/wireless communication network using a Transmission Control Protocol (TCP). More particularly, the present invention relates to a method and system for estimating an average bandwidth in a wired/wireless communication network with a fast varying data rate.

2. Description of the Related Art

The Internet Engineering Task Force's (IETF's) Request For Comments (RFC) 793 describes a Transmission Control Protocol (TCP) as a protocol for data transmission over the Internet. TCP is intended to transmit data in the form of packets between nodes connected to the Internet. TCP works as a protocol for a transport layer above an Internet Protocol (IP) for a network layer. Thus, TCP is typically called TCP/IP.

While TCP uses IP as the network layer like User Datagram Protocol (UDP), it provides a connection-oriented service and a reliable communication service. The connection-oriented service means that communication nodes corresponding to a client and a server have to establish a connection. TCP, which controls the data rate of a transmission node, taking congestion into account, is under consideration for use as the transport layer in an integrated wired and wireless network. TCP implements a congestion control mechanism based on Acknowledgement (Ack) delivered from a reception node to a transmission node to notify of successful data reception, a window notified from the reception node to the transmission node, and timeout.

Besides congestion control, TCP is characterized by flow control. Flow control is a scheme for controlling and defining the amount of data to be transmitted from the transmission node in the reception node. TCP uses a buffer for buffering data from an application program at a higher layer and defines the window to decide the size of transmission data. By using TCP, as many data as the number of bytes defined in the window can be transmitted. A sliding window technique is used for flow control.

The congestion control is used for effective retransmission where the reception node suffers from data loss due to network congestion. To probe the bandwidth of the current network, the transmission node increases its data rate by a Slow Start algorithm. If data loss occurs, the lost packets are retransmitted and the data rate is recovered by a congestion avoidance algorithm.

TCP versions include Tahoe, Reno and Vegas. In TCP communications, upon receipt of a data segment from the transmission node, the reception node transmits an Ack with the same sequence number as the data segment. The data segment is a data block unit transmitted by the TCP, Protocol Data Unit (PDU). Even though the transmission node does not Ack from the reception mode, the transmission node transmits as many data segments as the size of a predetermined Congestion Window (CWND). If receiving Acks with the same sequence number, that is, duplicate Acks, the transmission node retransmits the data segment with the sequence number. Even though the transmission node fails to receive the duplicate Acks, if the transmission node does not receive an Ack within a predetermined timeout interval after transmitting a data segment to the reception node, the transmission node retransmits the data segment.

Meanwhile, Slow Start is an algorithm for stably controlling the amount of transmission data using a transmission node CWND. The CWND is used at an initial TCP connection and at timeout. If the CWND is larger than a slow start threshold or if the transmission node receives a predetermined number (usually three) of duplicate Acks and thus recognizes the loss of data transmitted to the reception node, the Slow Start algorithm is terminated.

The CWND is increased by as much as the number of Acks received for each Round Trip Time (RTT). The RTT is a round trip delay measured between the transmission node and the reception node. In practice, the transmission node transmits data based on the smaller between the CWND of the transmission node and an Advertised Window (AWND) size indicating a remaining buffer size. That is, the transmission node transmits data based on Min(CWND, AWND). AWND is reported to the transmission node by the reception node. The AWND upper limit includes, for example, 64 Kbytes and used for flow control of the reception node.

A description will be made below of congestion control in the TCP versions, Tahoe, Reno and Vegas.

<TCP Tahoe>

In TCP Tahoe, the size of a transmission window is increased until congestion occurs in the Slow Start algorithm. The TCP Tahoe control implementation consists of a slow start phase in which the window size is increased quickly to a given Slow Start Threshold (SSTH) and a congestion avoidance phase in which the window size is increased slowly to avoid congestion after reaching the SSTH.

The slow start phase (CWND<SSTH) is expressed as
CWND(t+1)=CWND(t)+1, if CWND(t)<SSTH(t) (1)

and the congestion avoidance phase (CWND≧SSTH) is expressed as

$$CWND ( t + 1 ) = CWND ( t ) + \frac{1}{CWND ( t )} , \\ if CWND ( t ) \geq SSTH ( t ) \qquad ( 2 )$$

The TCP continues to increase a data rate according to the CWND increased as expressed in Eq. (1) and Eq. (2). Consequently, congestion occurs at a certain time point.

The TCP notifies the transmission node of the last packets received normally each time the TCP receives a packet. The TCP notification to the transmission node is called Cumulative Ack. Accordingly, if a packet is lost during transmission, the same Ack is received repeatedly. The same Ack is a duplicate Ack. When the transmission node receives three duplicate Acks, fast retransmission occurs in which the transmission node attempts to retransmit before a timeout, which determines that a packet loss has occurred. This algorithm is called fast retransmission. The change of CWND in TCP Tahoe characterized by the slow start, congestion avoidance, and fast retransmission is illustrated in FIG. 1. The CWND change model illustrated in FIG. 1 is called Additive Increase Multiple Decrease (AIMD).

<TCP Reno>

TCP Reno retains the basic principle of TCP Tahoe, such as the slow start, congestion avoidance, and fast retransmission. TCP Reno differs from TCP Tahoe in that once three duplicate Acks are received, congestion avoidance is performed from SSTH without the slow start because there is no need for the slow start (that is, bandwidth probing) in the case of receiving three duplicate Acks due to Bandwidth Delay Product (BDP).

<TCP Vegas>

TCP Tahoe and TCP Reno use packet loss caused by the limited buffer capacity of a communication node as a measure of congestion, whereas TCP Vegas considers end-to-end queuing delay as a congestion measure. In TCP Vegas, the number of packets in a current queue in the current network is estimated based on the end-to-end queuing delay RTT and the window size which is correspondingly maintained at a predetermined level.

In general, TCP transmission capacity is defined by BDP. The TCP transmission capacity C, bandwidth B, and the end-to-end queuing delay, that is, the RTT between the transmission node and the reception node are in the following relationship.
C=B×RTT (3)

According to the above TCP transmission capacity model, the network bandwidth is estimated to be C/RTT. However, since the bandwidth is a sample bandwidth at a particular time instant, the bandwidth is not accurate enough to be used as the average bandwidth of a network having a time-varying rate like TCP transmission.

Accordingly, there is a need for an improved method and system for estimating an average bandwidth comprising a time-varying rate during TCP transmission.

### SUMMARY OF THE INVENTION

An aspect of exemplary embodiments of the present invention is to address at least the above problems and/or disadvantages and to provide at least the advantages below. Accordingly, an aspect of exemplary embodiments of the present invention is to provide a method and system for estimating an average bandwidth in a TCP network in a wired/wireless communication network with a fast varying rate.

The present invention also provides a method and system for estimating an average bandwidth at a transmission node, reception node, and relay node in a TCP-based wired/wireless communication network with a fast varying rate.

According to one aspect of exemplary embodiments the present invention, in a method of estimating an average bandwidth in a TCP network, differences between inter-arrival times and sequence numbers of current and previous Acks are calculated. The estimated bandwidth of the previous Ack and a sample bandwidth of the current Ack are calculated. The inter-arrival time of the current Ack is compared with the inter-arrival time of the previous Ack. A first weight to be multiplied by the estimated bandwidth of the previous Ack and a second weight to be multiplied by the sample bandwidth of the current Ack, according to the comparison, are determined. The bandwidth of the current Ack is estimated by weighting the estimated bandwidth of the previous Ack with the first weight and weighting the sample bandwidth of the current Ack with the second weight.

According to an aspect of exemplary embodiments of the present invention, a TCP network system for rate control based on an estimated average bandwidth includes at least one first communication node for transmitting a packet and receiving an Ack for the transmitted packet, and at least one second communication node for receiving the packet and transmitting the Ack for the received packet to the first communication node. At least one of the first and second communication nodes calculates a difference between an inter-arrival time of the current Ack and an inter-arrival time of a previous Ack, and the difference between a sequence number of the current Ack and a sequence number of the previous Ack, calculates an estimated bandwidth of the previous Ack and a sample bandwidth of the current Ack, compares the inter-arrival time of the current Ack with the inter-arrival time of the previous Ack, determines a first weight to be multiplied by the estimated bandwidth of the previous Ack and a second weight to be multiplied by the sample bandwidth of the current Ack, according to the comparison, and estimates the bandwidth of the current Ack by weighting the estimated bandwidth of the previous Ack with the first weight and weighting the sample bandwidth of the current Ack with the second weight.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will become more apparent from the following detailed description taken in conjunction with the accompanying drawings, in which:

FIG. 1 is a graph illustrating congestion control in a TCP network;

FIG. 2 is a schematic block diagram to a TCP network applied in an exemplary embodiment of the present invention; and

FIG. 3 is a flowchart illustrating an operation for estimating an average bandwidth in the TCP network according to an exemplary embodiment of the present invention.

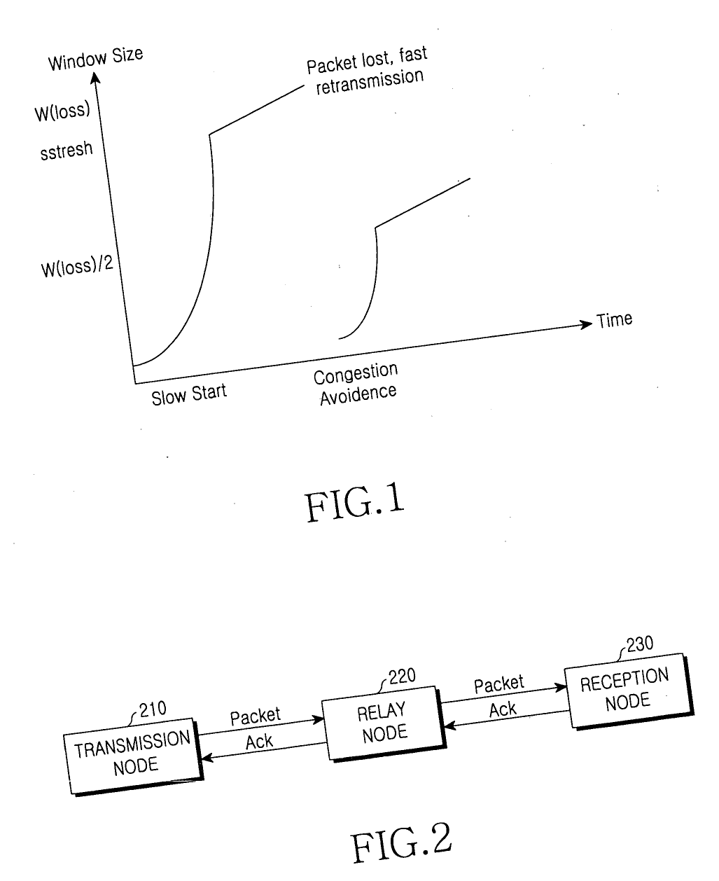

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention is intended to provide a method of estimating an average bandwidth in real time during packet transmission by TCP. The average bandwidth estimation takes place in a transmission node, reception node, and relay node.

FIG. 2 is a schematic block diagram of a TCP network according to an exemplary embodiment of the present invention. The TCP network includes a transmission node 210 for transmitting a packet, reception node 230 where the packet is destined, and relay node 220 for forwarding the packet from the transmission node 210 to the reception node 230. The transmission node 210 reception node 230 and relay node 220 may be network elements in a wired or wireless communication network. For example, in a wireless network, the transmission node 210 may be a mobile station, Personal Digital Assistant (PDA), or Access Terminal (AT). The reception node 230 may be a host connected to an IP network, and the relay node 220 may be a base station or an Access Router (AR). In an exemplary implementation, while the transmission node 210, relay node 220, and reception node 230 each are shown in a single form, a plurality of nodes may form a network.

Referring to FIG. 2, the transmission node 210 transmits a packet to the reception node 230 via the relay node 220. The reception node 230, which has received the packet successfully, transmits an Acknowledgement (Ack) indicating the successful packet reception to the transmission node 210 via the relay node 220. According to a congestion state during the packet and Ack transmission, rate control is performed at each node. For stable rate control, accurate bandwidth estimation is required. The bandwidth estimation and associated rate control in the transmission node 210, reception node 230 and relay node 220 can be done through interworking with previous TCP transmission. In an exemplary implementation, rate control at each node is first described below, followed by a description of bandwidth estimation for the rate control.

<TCP Rate Control in Transmission Node>

TCP rate control in the transmission node 210 is provided in Eq. (4) with a minimum bandwidth threshold a and a maximum bandwidth threshold β by a higher-layer application program or on a link, which
B_{estimated}<α:increase CWND
B_{estimated}>β:decrease CWND (4),
α≦B_{estimated}≦β:keep CWND

where B_{estimated} denotes an estimated average bandwidth.

In the transmission node 210, (CWND) typically increases by as much as the number of Acks received from the reception node 230 for a Round Trip Time (RTT). As described in Eq. (4), if B_{estimated} is less than α, CWND is increased in order to increase a data rate. In the opposite case, that is, if B_{estimated} is greater than α, CWND is decreased in order to decrease the data rate. However, if B_{estimated} is between α and β, CWND is kept unchanged.

<TCP Rate Control in Reception Node>

TCP rate control in the reception node 230 is provided in Eq. (5), which
B_{estimated}≦β:increase AWND or send maximum AWND in Ack transmission
B_{estimated}>β:decrease AWND in Ack transmission (5),

where AWND, which is used for flow control in the reception node 230, represents an Advertised Window indicating a current remaining buffer size of the reception node 230.

As noted from Eq. (5), if B_{estimated} is equal to or less than β, the reception node 230 transmits an increased AWND or a maximum AWND to the transmission node 210 in an Ack transmission. On the other hand, if B_{estimated} is greater than β, the reception node 230 transmits a decreased AWND to the transmission node 210 in an Ack transmission.

<TCP Rate Control in Relay Node>

TCP rate control in the relay node 220 is provided Eq. (6), which
B_{estimated}≦β:increase AWND or send maximum AWND in Ack transmission to transmission node
B_{estimated}>β:decrease AWND in Ack transmission to transmission node (6).

The relay node 220 is included in the TCP rate control, according to an exemplary embodiment of the present invention. For transmission to the transmission node 210, the relay node 220 measures an average bandwidth and converts the AWND value from the reception node 210 in real time according to the average bandwidth measurement, for For TCP rate control by Eq. (4), Eq. (5) and Eq. (6) in the transmission node 210, reception node 230, and relay node 220, the current average bandwidth must be measured in real time.

Regarding average bandwidth estimation, in TCP transmission, the sample bandwidth is estimated at each node during transmission of a k^{th} Ack by

$${B}_{k} = \frac{AckedBits ( k )}{{Ack}_{diff} ( k )} \qquad ( 7 )$$

Ack_{diff}(k)=Ackₜᵢₘₑ(k)−Ackₜᵢₘₑ(k−1)
AckedBits(k)=Seq(k)−Seq(k−1) (8).

In Eq. (7) and Eq. (8), Ack_{diff} denotes the difference between the inter-arrival time of a k^{th} Ack (Ackₜᵢₘₑ(k)) and the inter-arrival time of a (k−1)^{th} Ack (Ackₜᵢₘₑ(k−1)). AckedBits denotes the difference between the sequence number of the k^{th} Ack (Seq(k)) and the sequence number of the (k−1)^{th} Ack (Seq(k−1)). According to Eq. (7), the sample bandwidth Bₖ is calculated by dividing Ack_{diff} by AckedBits.

In a fast varying traffic state, the calculated Bₖ is a lot different from an actual bandwidth. Hence, Bₖ may adversely affect TCP rate control described by Eq. (4), Eq. (5) and Eq. (6). In this context, a moving average bandwidth (hereinafter, referred to as “estimated bandwidth”) is calculated by Eq. (9) and Eq. (10) for a more reliable average bandwidth estimation for use in bandwidth control for a network in a fast varying traffic state, which
B_{estimated} _{ₖ}=p×B_{estimated}_{ₖ₋₁}+q×Bₖ (9),

where Be_{estimated}_{ₖ} denotes an estimated bandwidth of the current Ack calculated by weighting an estimated bandwidth of the previous Ack, B_{estimated}_{ₖ₋₁} and the sample bandwidth of the current Ack, Bₖ with p and q. In Eq. (10), p and q are expressed as

$$p = \frac{{Ack}_{diff} ( k )}{{Ack}_{diff} ( k ) + {Ack}_{diff} ( k - 1 )} \\ q = \frac{{Ack}_{diff} ( k - 1 )}{{Ack}_{diff} ( k ) + {Ack}_{diff} ( k - 1 )} , \qquad ( 10 )$$

where p is a weight (a first weight) reflecting the inter-arrival time of the current Ack, Ackₜᵢₘₑ(k) and q is a weight (a second weight) reflecting the inter-arrival time of the previous Ack, Ackₜᵢₘₑ(k−1). The first and second weights are used as coefficients for a low-pass filter in an actual bandwidth estimator.

In accordance with exemplary embodiments of the present invention, if the inter-arrival time of the current Ack is longer than the previous Ack, p is set to be larger than q in order to reflect the effects of the previous estimated bandwidth more than the current sample bandwidth. If the inter-arrival time of the current Ack is shorter than the previous Ack, p is set to be less than q in order to reflect the effects of the current sample bandwidth more than the previous estimated bandwidth. Accordingly, p and q are empirically produced.

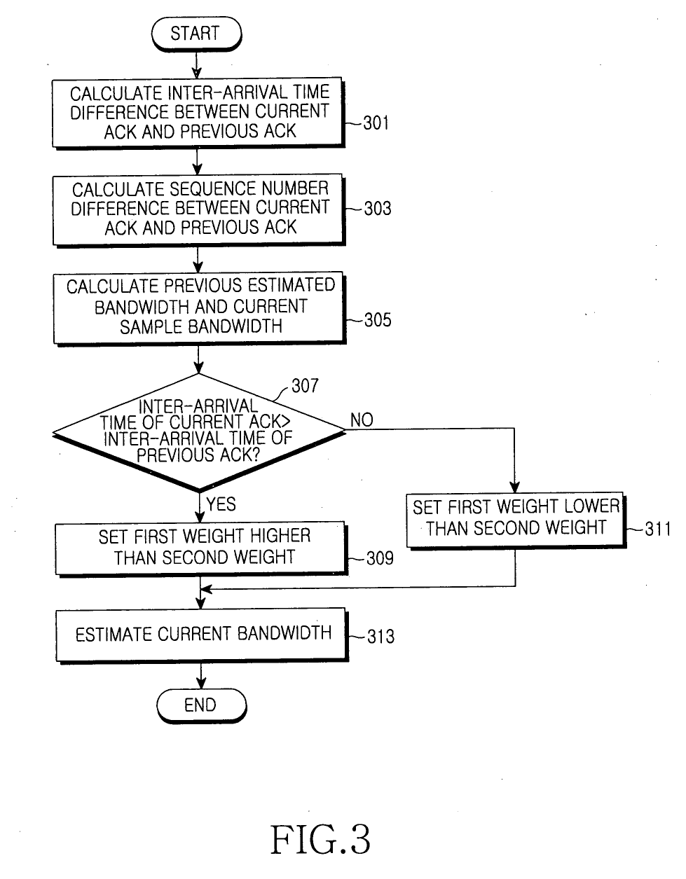

FIG. 3 is a flowchart illustrating an operation for estimating an average bandwidth in the TCP network according to an exemplary embodiment of the present invention. The average bandwidth estimation is carried out in each of the transmission node, reception node, and relay node.

Referring to FIG. 3, the difference between the inter-arrival times of the current Ack and the previous Ack, and the difference between the sequence numbers of the current and previous Acks are calculated by Eq. (7) in steps 301 and 303. The sample bandwidth of the current Ack is obtained by computing Eq. (7) using the inter-arrival time difference and the sequence number difference and the previous estimated bandwidth being the average bandwidth calculated when receiving the previous Ack is retrieved in step 305.

In step 307, the inter-arrival time of the current Ack is compared with the previous Ack. If the inter-arrival time of the current Ack is longer than the previous Ack, the first weight p to be multiplied by the previous estimated bandwidth B_{estimated}_{ₖ₋₁}, is set to be higher than the second weight q to be multiplied by the current sample bandwidth Bk in step 311.

In step 313, a moving average bandwidth (that is, the current estimated bandwidth) is calculated by multiplying the first and second weights by the previous estimated bandwidth and the current sample bandwidth, respectively, and then adding the products according to Eq. (9). In the weighting, when the Ack arrives in a shorter time, which is a decreased interval between Acks, the current sample bandwidth is reflected more in average bandwidth estimation. Accordingly, an instantaneous change in the actual bandwidth is fast reflected fast in the average bandwidth.

On the other hand, if the interval between Acks increases, the previous estimated bandwidth is reflected in the current estimated bandwidth more than the current sample bandwidth in order to prevent an abrupt drop in the current estimated bandwidth. The upper limit of bandwidth may be set for bandwidth estimation for TCP rate control. In an exemplary implementation, with the use of weights, the current bandwidth may be reliably estimated using an upper limit for TCP rate control according to changes in the time interval between Ack packets.

As described above, exemplary embodiments of the present invention advantageously enables efficient average bandwidth estimation for the case of a fast varying bandwidth in TCP rate control. Thus, a more accurate TCP rate control can be achieved.

While the invention has been shown and described with reference to a certain exemplary embodiments thereof, it will be understood by those skilled in the art that various changes in form and details may be made therein without departing from the spirit and scope of the invention as defined by the appended claims.

What is claimed is:

1. A method of estimating an average bandwidth in a Transmission Control Protocol (TCP) network, comprising:
calculating a difference between an inter-arrival time of a current acknowledgement (Ack) and an inter-arrival time of a previous Ack, and the difference between a sequence number of the current Ack and a sequence number of the previous Ack;
calculating an estimated bandwidth of the previous Ack and a sample bandwidth of the current Ack;
comparing the inter-arrival time of the current Ack with the inter-arrival time of the previous Ack;
determining a first weight to be multiplied by the estimated bandwidth of the previous Ack and a second weight to be multiplied by the sample bandwidth of the current Ack according to the comparison; and
estimating the bandwidth of the current Ack by weighting the estimated bandwidth of the previous Ack with the first weight and weighting the sample bandwidth of the current Ack with the second weight.

2. The method of claim 1, wherein the determining of the first weight and second weight comprises setting the first weight to be higher than the second weight, if the inter-arrival time of the current Ack is longer than the inter-arrival time of the previous Ack.

3. The method of claim 2, wherein the determining of the first weight and the second weight comprises the step of setting the second weight to be higher than the first weight, if the inter-arrival time of the current Ack is shorter than the inter-arrival time of the previous Ack.

4. The method of claim 3, wherein the first weight is calculated by
$$p = \frac{{Ack}_{diff} ( k )}{{Ack}_{diff} ( k ) + {Ack}_{diff} ( k - 1 )} \qquad ( 11 )$$
where p comprises the first weight, Ackdiff(k) comprises the difference between the inter-arrival times of the current Ack and the previous Ack, and k comprises a reception number of the current Ack.

5. The method of claim 4, wherein the second weight is calculated by
$$q = \frac{{Ack}_{diff} ( k - 1 )}{{Ack}_{diff} ( k ) + {Ack}_{diff} ( k - 1 )} \qquad ( 12 )$$
where q comprises the second weight.

6. A Transmission Control Protocol (TCP) network system for rate control based on an estimated average bandwidth, comprising:
at least one first communication node for transmitting a packet and receiving an acknowledgement (Ack) for the transmitted packet; and
at least one second communication node for receiving the packet and transmitting the Ack for the received packet to the first communication node,
wherein at least one of the first and second communication nodes calculates a difference between an inter-arrival time of a current Ack and an inter-arrival time of a previous Ack, and a difference between a sequence number of the current Ack and a sequence number of the previous Ack, calculates an estimated bandwidth of the previous Ack and a sample bandwidth of the current Ack, compares the inter-arrival time of the current Ack with the inter-arrival time of the previous Ack, determines a first weight to be multiplied by the estimated bandwidth of the previous Ack and a second weight to be multiplied by the sample bandwidth of the current Ack according to the comparison, and estimates the bandwidth of the current Ack by weighting the estimated bandwidth of the previous Ack with the first weight and weighting the sample bandwidth of the current Ack with the second weight.

7. The TCP network system of claim 6, wherein the first weight is set to be higher than the second weight, if the inter-arrival time of the current Ack is longer than the inter-arrival time of the previous Ack.

8. The TCP network system of claim 7, wherein the second weight is set to be higher than the first weight, if the inter-arrival time of the current Ack is shorter than the inter-arrival time of the previous Ack.

9. The TCP network system of claim 7, wherein the first weight is calculated by
$$p = \frac{{Ack}_{diff} ( k )}{{Ack}_{diff} ( k ) + {Ack}_{diff} ( k - 1 )} \qquad ( 13 )$$
where p comprises the first weight, Ack_{diff}(k) comprises the difference between the inter-arrival times of the current Ack and the previous Ack, and k comprises a reception number of the current Ack.

10. The TCP network system of claim 9, wherein the second weight is calculated by
$$q = \frac{{Ack}_{diff} ( k - 1 )}{{Ack}_{diff} ( k ) + {Ack}_{diff} ( k - 1 )} \qquad ( 14 )$$
where q comprises the second weight.
